(19) United States
(12) Patent Application Publication
(10) Pub. No.: US 2005/0135460 A1
(43) Pub. Date: Jun. 23, 2005

(54) Method and apparatus for estimating a SIR of a pilot channel in a MC-CDMA system

(76) Inventor: Hidenori Akita, Tokyo (JP)

Correspondence Address: MOTOROLA INC, 600 NORTH US HIGHWAY 45, ROOM AS437, LIBERTYVILLE, IL, 60048-5343, US

(21) Appl. No.: 10/743,227

(22) Filed: Dec. 22, 2003

(51) Int. Cl. H04B 1/707

(52) U.S. Cl. 375/148

(57) ABSTRACT

A MC-CDMA handset has a receiver (30) that estimates SIR based on a spread factor of a pilot channel. More particularly, a spread spectrum signal including a pilot channel and multiple data channels is received. The pilot channel is despread using a spread factor (SF). The SIR for the despread pilot channel is calculated and stored in a memory (34). The SF is then incremented and used to despread the pilot channel again, and this process is repeated for all of SF. The stored SIRs are compared to a threshold value in ascending order of the SFs. The first SIR value to fall below the threshold value is used as the estimated SIR result.

### BACKGROUND OF THE INVENTION

The present invention relates generally to communications systems, and more particularly, to a method and apparatus for estimating a Signal to Interference Ratio (SIR) by controlling a spread factor of a pilot channel in a Multi-Carrier Code Division Multiple Access (MC-CDMA) communications system.

CDMA has recently been used in the United States for digital cellular telephone systems. CDMA uses a spread spectrum technique, in which the signal energy of each channel is spread over a wide frequency band, and in which multiple channels each corresponding to a different system user occupy the same frequency band. CDMA offers the advantages of efficient use of the available frequency spectrum and, by spreading the signal over a wide frequency band, resistance to signal fading is achieved. Today, variations of CDMA are being developed in order to improve frequency efficiency.

MC-CDMA is a combination of Orthogonal Frequency Division Multiplexing (OFDM) and CDMA. OFDM is a form of multi-carrier modulation (MCM), which transmits data by dividing the bit stream into parallel, lower bit rate, bit streams. OFDM maintains the sub-carriers orthogonal to one another. Thus, with MC-CDMA, each data symbol is spread over multiple sub-carriers and OFDM symbol with a user-specific code and spread data symbol by the spreading code and is transmitted on another sub-carrier and OFDM symbol. Generally, the code length of the spreading code is defined by a spreading factor (SF). For example, if SF=16, the spreading code is 16 chips in length. That is, sixteen symbols (chips) are transmitted for every information symbol. The SF typically varies between 4 and 256. To further improve throughput and performance, adoptive modulation and coding (AMC) and equalization schemes are used.

Effective power control is a critical aspect of a CDMA system, so that signals transmitted by devices near to a base station do not overpower the signals transmitted by devices that are far from the base station. For example, if all mobile devices transmitted at a fixed power, then those devices closer to the base station would overpower the signals of those devices farther from the base station. Thus, when the mobile device is near to the base station, less power is required to maintain an acceptable SIR than when the mobile device is far from the base station. Effective power control can increase the battery life of the mobile device too.

Currently, power control is performed by estimating the SIR of received signals. If the SIR of a signal received by the mobile device is lower than a threshold value, an adjustment signal is transmitted to the base station to increase transmission power. Typically, SIR is estimated using a pilot channel. The pilot channel is an unmodulated, direct sequence spread spectrum signal transmitted at all times by each CDMA base station. The mobile device monitors the pilot channel to acquire the timing of the forward CDMA channels and more easily determine the spreading code sequence and spreading code phase. In current systems, the SF of the pilot channel is a large number, such as 256. Thus, in SIR estimation, a receiver adopts the SF of the pilot channel.

In a MC-CDMA system using a code multiplexed pilot channel, SIR estimation accuracy is adversely affected if a large SF is assigned to the pilot channel. Further, AMC and equalization require high SIR estimation accuracy.

Thus, it would be advantageous to have a CDMA receiver that can estimate SIR with high accuracy.

### BRIEF DESCRIPTION OF THE DRAWINGS

The following detailed description of a preferred embodiment of the invention will be better understood when read in conjunction with the appended drawings. For the purpose of illustrating the invention, there is shown in the drawings an embodiment that is presently preferred. It should be understood, however, that the invention is not limited to the precise arrangement and instrumentalities shown. In the drawings:

FIG. 1 is a flow chart of a method for calculating SIR in accordance with an embodiment of the present invention;

FIG. 2 is a schematic block diagram of a portion of a receiver in accordance with an embodiment of the present invention;

FIG. 3 is a graph illustrating an example of spread factor selection in accordance with an embodiment of the present invention; and

FIG. 4 is graph illustrating a plot of RMS of SIR estimation error versus Cumulative Distribution Function (C.D.F.) for a conventional system and a system in accordance with the present invention.

### DETAILED DESCRIPTION OF A PREFERRED EMBODIMENT

The detailed description set forth below in connection with the appended drawings is intended as a description of the presently preferred embodiment of the invention, and is not intended to represent the only form in which the present invention may be practiced. It is to be understood that the same or equivalent functions may be accomplished by different embodiments that are intended to be encompassed within the spirit and scope of the invention. Further, although the invention is illustrated in a MC-CDMA system, it may be applied to other systems, such as a DS-CDMA system. In the drawings, like numerals are used to indicate like elements throughout.

In accordance with the present invention, a method of estimating a SIR of a pilot channel in a MC-CDMA system includes the steps of receiving a spread spectrum signal including a pilot channel signal and a plurality of data channel signals and despreading the pilot channel signal using a plurality of Spread Factors (SF). The SIR for each of the plurality of SF is determined and then the determined SIRS are compared with a predetermined threshold value. The selected estimated SIR is the first SIR that is below the predetermined threshold value, when the SIRS are compared to the threshold value in ascending order of the SF.

In accordance another embodiment of the present invention, a receiver circuit for estimating a SIR of a received spread spectrum signal including a pilot channel and a plurality of data channels, includes a pilot channel despreader that receives the spread spectrum signal and despreads the pilot channel using a predetermined SF to generate a corresponding despread pilot channel signal. An average pilot symbol module is connected to the pilot channel despreader and receives the despread pilot channel signal and filters noise therefrom to generate a filtered despread signal. A first average power module is connected to the average pilot symbol module for receiving the filtered despread pilot channel signal and generating a first signal power signal. A first mixer, connected to the pilot channel despreader and the average pilot symbol module, combines the filtered despread signal and the despread pilot channel signal to form a first combined signal. A second average power module is connected to the first mixer for receiving the first combined signal and generates an interference power signal. A second mixer, connected to the first and second average power modules, generates a second signal power signal. A signal interference module, connected to the second mixer and the second average power module, generates a SIR for the pilot channel signal with the first SF. A memory is connected to the signal interference module and stores the generated SIR. An incrementor, connected to the pilot channel despreader, increments the value of the SF so that a next SIR is generated corresponding to the incremented SF. A comparator is connected to the memory and compares each of the generated SIRs with a predetermined threshold value. The estimated SIR is determined as the first SIR that is below the predetermined threshold value.

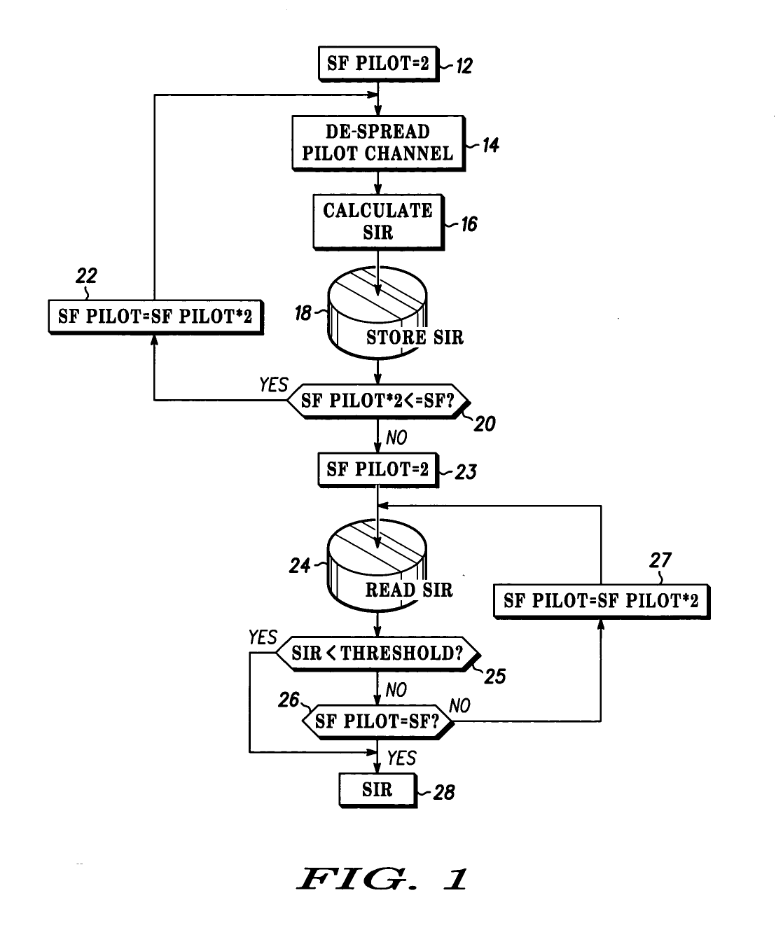

Referring now to FIG. 1, a flow chart of a method of estimating a SIR of a pilot channel in a MC-CDMA system is shown. The method is described with reference to a MC-CDMA system. However, as will be understood by those of skill in the art, the method may be used for other communication environments, such as DS-CDMA. The method applies to a mobile unit in communication with a base station. According to the method, a receiver circuit of a mobile unit receives a spread spectrum signal including a pilot channel and a plurality of data channels. A pilot channel spread factor (SFpilot) is set at step 12 to an initial value. In a presently preferred embodiment, the initial value is two (2). At step 14, the pilot channel signal is despread using the spread factor SFpilot in a manner known to those of skill in the art. After the pilot channel is despread, the SIR is calculated at step 16. SIR calculation methods are well known in the art as SIR is commonly used in CDMA systems to control signal transmission power. At step 18, the calculated SIR is stored in a memory.

After the SIR is calculated and stored, at step 20 the spread factor SFpilot is multiplied by two (2) and the new value is checked to determine whether the new spread factor is greater than a maximum spread factor for the pilot channel. For example, if the spread factor ranges in value from 2 to 256, then the maximum spread factor is set at 256. If the new spread factor is not greater than the maximum spread factor, then the routine proceeds to step 22, where SFpilot is set to the new value of SFpilot*2. The new SFpilot signal is used to despread the pilot channel signal (step 14) and calculate a SIR value (step 16), and the next SIR value is stored in the memory (step 18). Thus, steps 14, 16, 18, 20 and 22 are repeated for a plurality of spread factors such that the pilot channel signal is despread using a plurality of spread factors. In the presently preferred embodiment, the spread factors used to despread the pilot channel signal and for which a SIR is calculated are SF=2ⁿ, where n=1 to m, with m being an integer that usually ranges from 1 to about 8. In addition, the SF is incremented in ascending order (2, 4, 8, 16, . . . ). On the other hand, if SFpilot*2 is greater than the predetermined maximum spread factor, then the loop is exited and the routines proceeds to step 23.

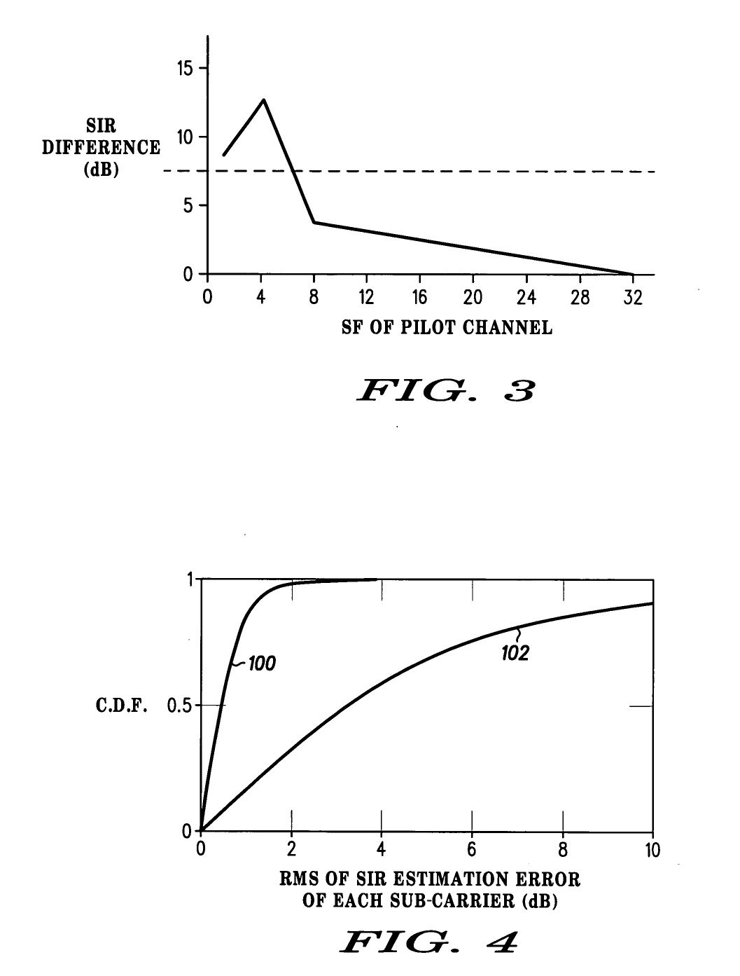

Referring now to FIGS. 1 and 3, the manner in which a preferred, estimated SIR value is determined will be explained. FIG. 3 is a graph showing SIR difference in db versus the spread factors used to calculate the SIR values. For the example depicted in FIG. 3, the maximum SF of the data channels is 8; the SF of the transmitted pilot channel is 32; the number of subcarriers is 768; the number of OFDM symbols per frame is 64; the SIR estimation cycle is 1 frame; the average received SIR is 12; the delay spread is 0.43 us; and SF ranged from 32 to 2 (i.e., 32, 16, 8, 4, 2). The dashed line represents a predetermined threshold value, which in this example is about 7 db. As discussed above, the pilot channel signal is despread using a plurality of SF, with SF being increased for each dispreading operation. Referring to FIG. 3, for SF=2, the SIR difference is about 9 db. SIR difference is the difference between the calculated SIR at each SF (step 16) and the estimated SIR of the pilot channel's SF (as specified by the base station). For SF=4, the SIR difference is about 12 db. Then, for the other SF values of this example, SF=8, 16 and 32, respective SIR difference values are 3 db, 2 db and 0 db. At step 23, SFpilot is set to two (2). Then, at step 24, the first stored SIR value is read from the memory. At step 25, the SIR difference value is compared to the threshold value. The calculated SIR value read with a non-orthogonal SF is different from the SIR value of the pilot channel SF transmitted by the base station. Therefore, a non-orthogonal SF can be readily detected by comparison to a threshold value. In FIG. 3, for SF=2 and SF=4, the SIR difference values are greater than the threshold value of about 7 db. However, for the next SF, SF=8, the SIR difference value 3 db is less than the threshold value. Thus, SF=8 is the first SF value where the SIR difference falls below the threshold value and so at step 28, the estimated SIR value is selected as the SIR value calculated for SF=8. It is noted that the routine could be varied, with the calculated SIR being compared to the threshold value prior to storing the SIR, so that and exiting the routine as soon as SIR is less than the threshold. It is also noted that in such a case, it may not be necessary to store all of the calculated SIR values in the memory.

Also at step 25, if the SIR difference is not less than the threshold value, then step 26 is executed, which checks if the SFpilot is equal to the value of SF, which is the SF of the pilot channel specified by the base station. If SFpilot is equal to the value of the SF, then that value for SFpilot is used as the estimated SIR (step 28). If SFpilot is not equal to the value of SF, then step 27 is executed. Step 27 increments SFpilot in the same manner as step 22. Then the routine proceeds to step 24 and reads out the next stored value from the memory, and steps 25, 25 and 27 are repeated.

At step 28, once the estimated SIR value is selected, the estimated SIR value is used by the CDMA receiver circuit to perform adaptive modulation and coding and equalization, as well as the other functions for which SIR is typically used, e.g., power control. The predetermined threshold does not have to be a fixed number, but could be a range, for example, the threshold could be from between about 5 db to about 10 db.

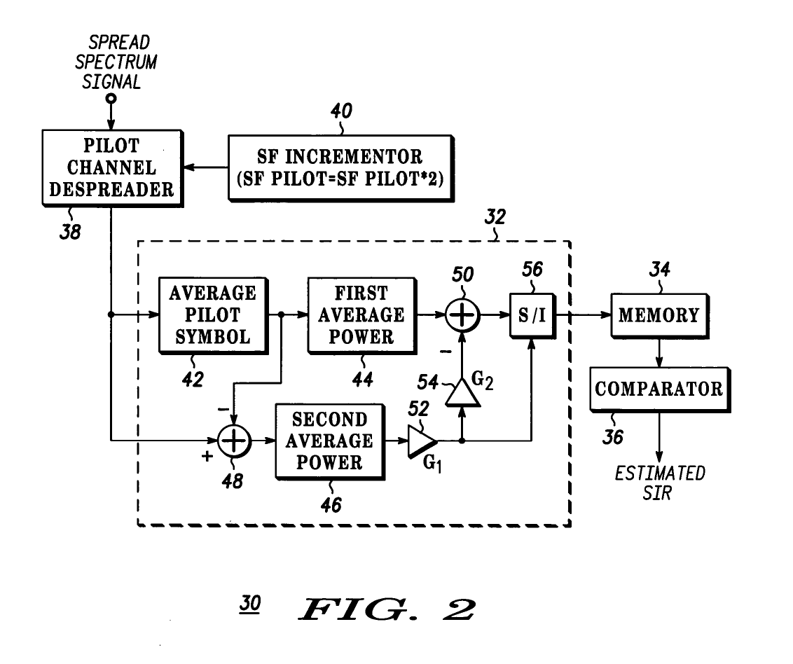

Referring now to FIG. 2, a schematic block diagram of a receiver circuit 30 that executes the aforedescribed method for estimating a SIR value is shown. The estimated SIR value may be used for AMC and equalization. The receiver circuit 30 includes a SIR processor 32 that generates particular SIR values for corresponding SF values. The SIR processor 32 is connected to a memory 34, which stores the calculated SIR values. A comparator 36 is connected to the memory 34 and compares the stored SIR values to a predetermined threshold value, as discussed above. It will be understood by those of ordinary skill in the art that each of the modules or blocks shown represent logical operations that may be performed by a microprocessor or digital signal processor, including the memory 34 and comparator 36, such as the MOTOROLA M-CORE processor. Alternatively, some of the modules may be implemented with separate circuitry or discrete components. It will further be appreciated that the receiver circuit 30 and the SIR processor 32 and the modules thereof are individually well known to those of skill in the art.

The receiver circuit 30 receives a spread spectrum signal including a pilot channel and a plurality of data channels. The spread spectrum signal is input to a pilot channel despreader 38 that despreads the pilot channel using a predetermined spread factor (SFpilot) to generate a corresponding despread pilot channel signal. According to the present invention, an incrementor 40 is connected to the pilot channel despreader 38 and provides SFpilot to the despreader 38. As previously discussed, the pilot channel signal is despread using a plurality of SF. The incrementor 40 provides the various SF to the despreader 38. In a preferred embodiment of the invention, the incrementor 40 determines SFpilot as SFpilot=2ⁿ, where n equals 1 to m, and m is an integer.

The SIR processor 32 includes an average pilot symbol module 42, first and second average power modules 44 and 46, first and second mixers 48 and 50, first and second gain elements 52 and 54, and a signal interference module 56. The average pilot symbol module 42 receives the despread pilot channel signal and filters noise therefrom to generate a filtered despread signal. The first and second average power modules 44 and 46 calculate signal power and interference power, respectively. The first mixer 48 subtracts the filtered signal from the unfiltered signal (the despread signal) and provides its output to the second average power module 46. The second mixer 50 subtracts the interference power signal generated by the second average power module 46 from the signal power signal generated by the first average power module 44, and the output of the second mixer 50 is provided to the signal interference module 56. The SIR processor 32 may have first and second gain elements 52 and 54 that follow the second average power module 46. The signal power and the signal interference power are input to the signal interference module 56 and a SIR value is generated for the SF designated by the incrementor 40. In an embodiment the SIR value is stored in the memory 34. In an alternate embodiment, the SIR processor generates the SIR difference for each SF and the SIR differences are stored in the memory.

The comparator 36 is connected to the memory 34. The stored SIR or SIR difference values are read from the memory and compared to a predetermined threshold value, as discussed above with reference to FIG. 1. An estimated SIR is determined (and output) as the first SIR value that is below the threshold value. It is noted that the circuit could be varied, with the calculated SIR differences being compared to the threshold value prior to storing the SIR values in the memory, or without storing the SIR values at all. The estimated SIR value output by the receiver circuit 30 is used by the MC-CDMA system for AMC and equalization.

FIG. 4 is a graph that plots the RMS value of the SIR estimation error of each sub-carrier (dB) versus C.D.F. The upper line 100 shows the result of a system according to the method of the present invention and the lower lines 102 shows the result using the transmitted pilot channel SF, as is done in the prior art. For the example depicted in FIG. 4, the maximum SF of the data channels is 2; the SF of the transmitted pilot channel is 32; the spreading code of the pilot channel is all 1; the number of subcarriers is 768; the number of OFDM symbols per frame is 64; the SIR estimation cycle is 1 frame; the average received SIR is 12 dB; and the delay spread is 0.43 us. FIG. 4 illustrates the SIR estimation accuracy of each sub-carrier. The present invention detects the SF for pilot channel dispreading. When C.D.F is 90%, the RMS SIR estimation error of the present invention is about 1.2 dB and the case using the transmitted pilot channel SF is about 10 dB. Thus, the present invention improves SIR estimation accuracy of each sub-carrier.

While the invention has been described in the context of a preferred embodiment, it will be apparent to those skilled in the art that the present invention may be modified in numerous ways and may assume many embodiments other than that specifically set out and described above. For example, the search algorithm may be implemented completely in hardware, completely in software, or with various combinations thereof. Accordingly, it is intended that the appended claims cover all modifications of the invention that fall within the scope of the invention.

1. A method of estimating a Signal Interference Ratio (SIR) of a pilot channel in a MC-CDMA system, comprising the steps of:
receiving a spread spectrum signal including a pilot channel signal and a plurality of data channel signals;
despreading the pilot channel signal using a plurality of Spread Factors (SF);
determining the SIR for each of the plurality of SF;
comparing each of the determined SIRs with a predetermined threshold value; and
selecting as the estimated SIR, the SIR of the first SF that is below the predetermined threshold value.

2. The method of estimating a SIR of a pilot channel of claim 1, further comprising the step of:
storing each of the determined SIRs for the plurality of SF in a memory.

3. The method of estimating a SIR of a pilot channel of claim 1, wherein the despreading step comprises:
despreading the pilot channel with an SF=2ⁿ, where n=1 to m, where m is an integer.

4. The method of estimating a SIR of a pilot channel of claim 1, further comprising the step of:
performing adaptive modulation and coding and equalization using the selected estimated SIR.

5. The method of estimating a SIR of a pilot channel of claim 1, wherein the predetermined threshold is between about 5 db and about 10 db.

6. A method of estimating a Signal Interference Ratio (SIR) of a pilot channel in a MC-CDMA system, comprising the steps of:
receiving a spread spectrum signal including a pilot channel signal and a plurality of data channel signals;
despreading the pilot channel signal using a plurality of Spread Factors (SF);
determining the SIR for each of the plurality of SF;
storing each of the determined SIRs for the plurality of SF in a memory;
comparing each of the determined SIRs with a predetermined threshold value; and
selecting as the estimated SIR, the SIR of the first SF that is below the predetermined threshold value.

7. The method of estimating a SIR of a pilot channel of claim 6, wherein the despreading step comprises despreading the pilot channel with an SF=2ⁿ, where n equals 1 to m, and m is an integer.

8. In an MC-CDMA system, a receiver circuit for estimating a Signal Interference Ratio (SIR) of a received spread spectrum signal including a pilot channel and a plurality of data channels, the receiver circuit comprising:
a pilot channel despreader that receives the spread spectrum signal and despreads the pilot channel using a predetermined spread factor (SF) to generate a corresponding despread pilot channel signal;
an average pilot symbol module, connected to the pilot channel despreader, that receives the despread pilot channel signal and filters noise therefrom, to generate a filtered despread signal;
a first average power module connected to the average pilot symbol module for receiving the filtered despread pilot channel signal and generating a first signal power signal;
a first mixer, connected to the pilot channel despreader and the average pilot symbol module, that combines the filtered despread signal and the despread pilot channel signal to form a first combined signal;
a second average power module connected to the first mixer for receiving the first combined signal and generating an interference power signal;
a second mixer, connected to the first and second average power modules, for generating second signal power signal;
a signal interference module, connected to the second mixer and the second average power module, for generating a signal interference ratio (SIR) for the pilot channel signal with the first SF;
a memory connected to the signal interference module for storing the generated SIR;
an incrementor, connected to the pilot channel despreader, for incrementing the value of the SF so that a next SIR is generated corresponding to the incremented SF;
a comparator for comparing each of the generated SIRs with a predetermined threshold value, wherein the estimated SIR is determined as the first SIR that is below the predetermined threshold value.

9. The receiver circuit of claim 8, wherein the incrementor increments the SF by multiplying the prior SF by two.

10. The receiver circuit of claim 8, further comprising a first gain element connected after the second average power module and before the second mixer and the signal interference module.

11. The receiver circuit of claim 10, further comprising a second gain element connected between the first gain element and the second mixer.
